(19) United States
(12) Patent Application Publication
(10) Pub. No.: US 2017/0183235 A1
(43) Pub. Date: Jun. 29, 2017

(54) SPARK PLASMA SINTERING-JOINED POLYCRYSTALLINE DIAMOND

(71) Applicant: Halliburton Energy Services, Inc., Houston, TX (US)

(72) Inventors: Qi Liang, Richmond, VA (US); William Brian Atkins, Houston, TX (US)

(73) Assignee: Halliburton Energy Services, Inc., Houston, TX (US)

(21) Appl. No.: 15/315,635

(22) PCT Filed: Aug. 5, 2015
(86) PCT No.: PCT/US2015/043771

§ 371 Date: Dec. 1, 2016

(51) Int. Cl. B23B 51/10; B01J 19/08; B24D 18/00; E21B 10/567; B01J 6/00; E21B 10/55; C01B 31/02

(52) U.S. Cl. CPC C01B 31/065; B01J 6/005; B01J 19/08; B24D 18/00; E21B 10/55; E21B 10/567; B01J 2219/0898; B01J 2219/0879

(57) ABSTRACT

The present disclosure relates to a spark plasma sintering-joined polycrystalline diamond and methods of joining polycrystalline diamond segments by spark plasma sintering. Spark plasma sintering produces plasma from a reactant gas found in the pores in the polycrystalline diamond segments. The plasma forms diamond bonds and/or carbide structures in the pores, which join the polycrystalline diamond segments to form a polycrystalline diamond element.

### TECHNICAL FIELD

The present disclosure relates to joined polycrystalline diamond and systems and methods for joining polycrystalline diamond.

### BACKGROUND

Polycrystalline diamond compacts (PDCs), particularly PDC cutters, are often used in earth-boring drill bits, such as fixed cutter drill bits. PDCs include diamond formed under high-pressure, high-temperature (HTHP) conditions in a press. In many cases, a PDC includes polycrystalline diamond formed and bonded to a substrate in as few as a single HTHP press cycle. A sintering aid, sometimes referred to in the art as a catalysing material or simply a “catalyst,” is often included in the press to facilitate the diamond-diamond bonds that participate both in forming the diamond and, optionally, in bonding the diamond to the substrate.

During use (e.g. while drilling), polycrystalline diamond cutters become very hot, and residual sintering aid in the diamond can cause problems such as premature failure or wear due to factors including a mismatch between the coefficients of thermal expansion (i.e. CTE mismatch) of diamond and the sintering aid. To avoid or minimize this issue, all or a substantial portion of the residual diamond sintering aid is often removed from the polycrystalline diamond prior to use, such as via a chemical leaching process, an electrochemical process, or other methods. Polycrystalline diamond from which at least some residual sintering aid has been removed is often referred to as leached regardless of the method by which the diamond sintering aid was removed. Polycrystalline diamond sufficiently leached to avoid graphitization at temperatures up to 1200° C. at atmospheric pressure is often referred to as thermally stable. PDCs containing leached or thermally stable polycrystalline diamond are often referred to as leached or thermally stable PDCs, reflective of the nature of the polycrystalline diamond they contain.

Leaching polycrystalline diamond sometimes needs to be joined to additional polycrystalline diamond. Prior attempts at joining polycrystalline diamond have focused on mechanical clamping or brazing.

### BRIEF DESCRIPTION OF THE DRAWINGS

A more complete and thorough understanding of the present embodiments and advantages thereof may be acquired by referring to the following description taken in conjunction with the accompanying drawings, which are not to scale, in which like reference numbers indicate like features, and wherein:

FIG. 1A is a schematic drawing in cross-section of unleached polycrystalline diamond;

FIG. 1B is a schematic drawing in cross-section of two adjacent leached polycrystalline diamond segments;

FIG. 1C is schematic drawing in cross-section of two adjacent leached polycrystalline diamond segments in the presence of a reactant gas prior to joining by spark plasma sintering; and

FIG. 1D is a schematic drawing in cross-section of two spark plasma sintering-joined polycrystalline diamond segments;

FIG. 2 is a schematic drawing in cross-section of a spark plasma sintering polycrystalline diamond assembly;

FIG. 3 is a schematic drawing of a spark plasma sintering system containing the assembly of FIG. 2.

FIG. 4A is a schematic drawing of a top view of a PDC cutter formed from laterally spark plasma sintering-joined polycrystalline diamond segments;

FIG. 4B is a schematic drawing of a non-diametrical cross-section of the PDC cutter of FIG. 4A;

FIG. 5 is a schematic drawing of a cross-section of a PDC cutter formed from vertically spark plasma sintering-joined polycrystalline diamond segments;

FIG. 6A is a schematic drawing of a top view of a PDC cutter formed from ring spark plasma sintering-joined polycrystalline diamond segments;

FIG. 6B is a schematic drawing in cross-section of the PDC cutter of FIG. 6A;

FIG. 7 is a schematic drawing of a fixed cutter drill bit containing a PDC cutter formed by spark plasma sintering.

### DETAILED DESCRIPTION

The present disclosure relates to spark plasma sintering-joined polycrystalline diamond segments and systems and methods for joining polycrystalline diamond segments using spark plasma sintering. Two or more polycrystalline diamond segments may be joined by placing them adjacent to one another, then spark plasma sintering them such that diamond bonds and/or carbide structures form between the segments to create a single spark plasma sintering-joined polycrystalline diamond element.

Polycrystalline diamond, particularly if leached, more particularly if sufficiently leached to be thermally stable, contains pores in which the diamond bonds and/or carbide structures form. When these pores in two different polycrystalline diamond segments are adjacent one another, the diamond bonds and/or carbide structures bridge the two elements and join them, typically by a covalent bond. Due to this pore filling, the resulting polycrystalline diamond may also be denser and may have a higher impact strength along these spark plasma sintered joints. In addition, impact strength, wear resistance, or other properties affected by the degree of bonding in the polycrystalline diamond may be improve near the joint because both the diamond bonds and carbide structures provide additional covalent bonds within the polycrystalline diamond. Furthermore, spark plasma sintered polycrystalline diamond near a joint is more thermally stable than unleached polycrystalline diamond with similar pore filling by the diamond sintering aid because carbide structures and diamond bonds have a coefficient of thermal expansion closer to that of the polycrystalline diamond than diamond sintering aids do.

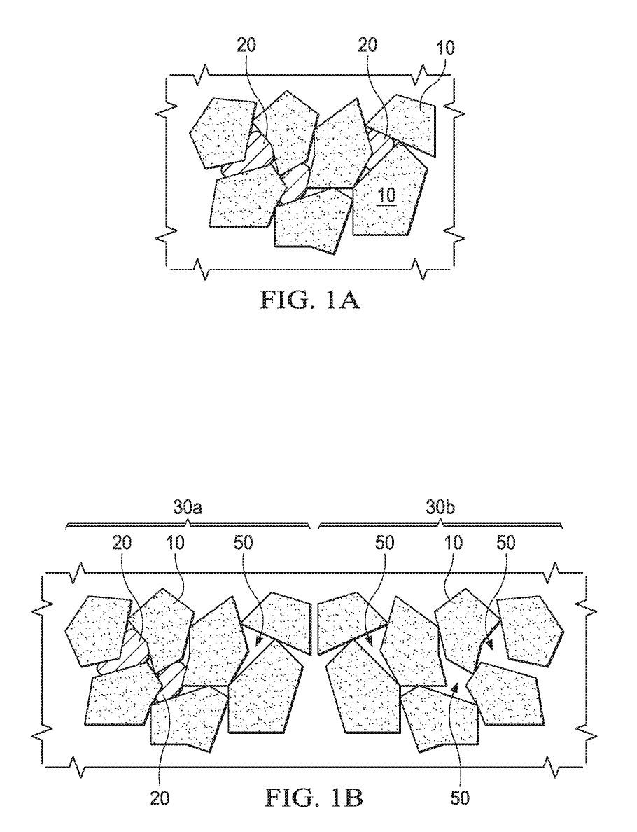

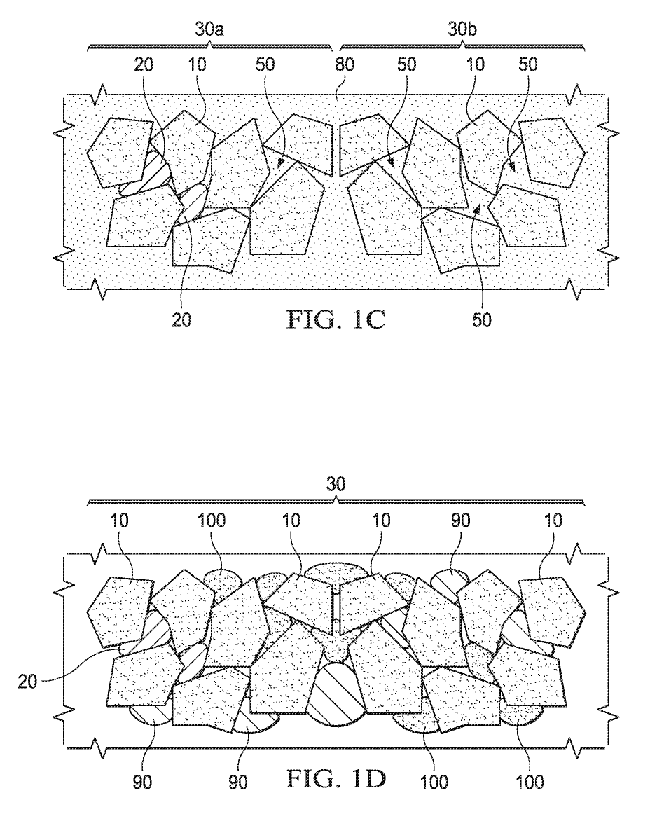

FIG. 1A depicts unleached polycrystalline diamond. Diamond sintering aid 20, in the form of a catalyst, is located between diamond grains 10. After leaching, as illustrated by two adjacent polycrystalline diamond segments 30a and 30b in FIG. 1B, pores 50 are present where catalyst 20 was previously located. Polycrystalline diamond segment 30a has been leached only to a depth of approximately one diamond grain size, so catalyst 20 may still be seen in the unleached portions. All or most catalyst has been removed from polycrystalline diamond segment 30b, which is TSP. Segments 30a and 30b are depicted with different leaching profiles to illustrate one example of how different polycrystalline diamond elements may be joined using spark plasma sintering. Provided there are sufficient pores that do not contain diamond sintering aid or that are only partially filled by diamond sintering aid near the surface, even unleached polycrystalline diamond elements may be joined using spark plasma sintering. The leached portion of the polycrystalline diamond may extend to any depth from any surface or all surfaces of the polycrystalline diamond or may even include all of the polycrystalline diamond. Less than 2% or less than 1% of the volume of the leached portion of the leached or thermally stable polycrystalline diamond is occupied by the diamond sintering aid, as compared to between 4% and 8% of the volume in unleached polycrystalline diamond.

In addition to differences in leaching profiles, such as illustrated in FIG. 1B, polycrystalline diamond segments to be joined may have other different polycrystalline diamond properties, such as different grain sizes, different pore sizes, different impact strengths, different abrasion resistances, other different properties, and they may have been formed using different diamond sintering aids.

During a spark plasma sintering process, the pores 50 in both polycrystalline diamond segment 30a and polycrystalline diamond segment 30b are filled with reactant gas 80, as shown in FIG. 1C. Although all pores 50 are illustrated as filled in FIG. 1C, filling of all pores does not always occur. At least a portion of the pores, at least 25% of the pores, at least 50% of the pores, at least 75% of the mores, or at least 99% of the pores in segments 30a and 30b may be filled with reactant gas. Alternatively, at least 95% of the pores, at least 90% of the pores, or at least 75% of the pores in segments 30a and 30b within 500 μm of the interface between segments 30a and 30b may be filled with reactive gas 80. Pore filling is evidenced by the formation of diamond bonds or carbide structures in the pores after spark plasma sintering.

Finally, in spark plasma sintered polycrystalline diamond illustrated in FIG. 1D, pores 50 left by catalyst removal are filled with diamond bonds 90 and/or carbide structures 100 that are formed from reactant gas 80, joining the polycrystalline diamond segment 30a and polycrystalline diamond segment 30b to form polycrystalline diamond element 30. Diamond bonds 90 and/or carbide structures may bond covalently to diamond grains 10 in segments 30a and 30b, thereby covalently bonding the segments in polycrystalline diamond element 30.

Although diamond bonds 90 are illustrated in FIG. 1D as distinguishable from diamond grains 10, they may be so similar and/or may fill any pores to thoroughly that they are not distinguishable.

Furthermore, although each filled pore 50 in FIG. 1D is illustrated as not entirely filled, it is possible for each pore to be substantially filled in one or both of the polycrystalline diamond segments 30a and 30b. Furthermore, although FIG. 1D illustrates some pores as unfilled, the disclosure include embodiments in which diamond bonds and/or carbide structures fill at least 25% of the pores, at least 50% of the pores, at least 75% of the mores, or at least 99% of the pores one or both of polycrystalline diamond segments 30a and 30b, or polycrystalline diamond element 30.

A higher percentage of filled pores and more complete filling of filled pores 50 typically results in a stronger joint that is less likely to fail during use of polycrystalline diamond element 30. This stronger joint may be achieved by increased covalent bonding between the segments 30a and 30b. It may also result in a more dense polycrystalline diamond or higher impact strength polycrystalline diamond adjacent the joint, or polycrystalline diamond with other improver properties as discussed herein adjacent that joint.

Diamond grains 10 may be of any size suitable to form polycrystalline diamond segments 30a and 30b or polycrystalline diamond element 30. They may vary in grain size throughout the polycrystalline diamond or in different regions of the polycrystalline diamond.

Reactant gas 80 may include a carbide-forming metal in gas form alone or in combination with hydrogen gas (H₂) and/or a hydrocarbon gas. The carbide-forming metal may include zirconium (Zr), titanium (Ti), silicon (Si), vanadium (V), chromium (Cr), boron (B), tungsten (W), tantalum (Ta), manganese (Mn), nickel (Ni), molybdenum (Mo), halfnium (Hf), rehenium (Re) and any combinations thereof. The gas form may include a salt of the metal, such as a chloride, or another compound containing the metal rather than the unreacted element, as metal compounds often form a gas more readily than do unreacted elemental metals. The hydrocarbon gas may include methane, acetone, methanol, or any combinations thereof.

Carbide structures 100 may include transitional phases of metal elements, such as zirconium carbide (ZrC), titanium carbide (TiC), silicon carbide (SiC), vanadium carbide (VC), chromium carbide (CrC), boron carbide (BC), tungsten carbide (WC), tantalum carbide (TaC), manganese carbide (MnC), nickel carbide (NiC), molybdenum carbide (MoC), halfnium carbide (HfC), rhenium carbide (ReC), and any combinations thereof.

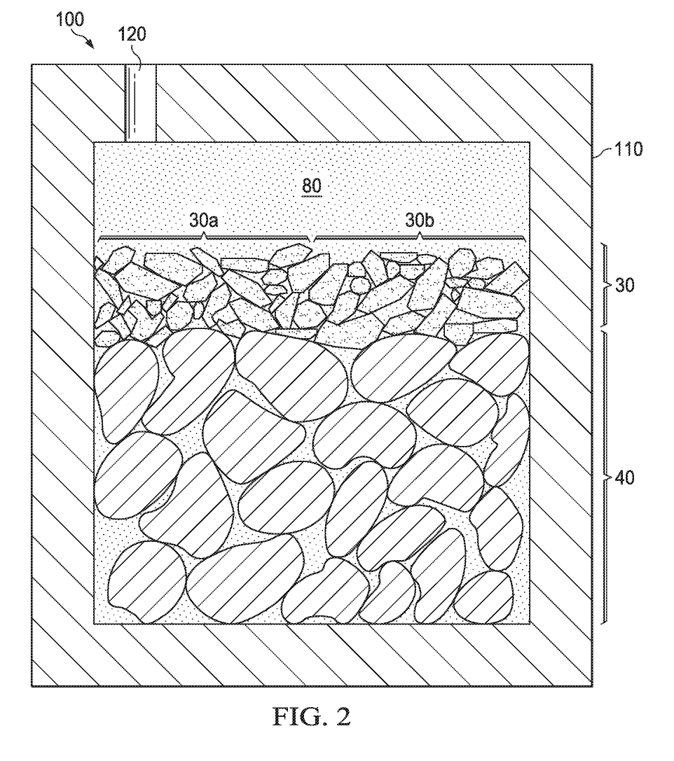

Prior to spark plasma sintering, two polycrystalline diamond segments 30a and 30b are placed in a spark plasma sintering assembly 100, such as the assembly of FIG. 2. The assembly includes a sealed sintering can 110 containing polycrystalline diamond elements 30a and 30b and optionally also a substrate 40, with reactant gas 80 adjacent to polycrystalline diamond elements 30a and/or 30b.

Substrate 40 may be the substrate on which leached one of polycrystalline diamond segments 30a or 30b was formed, or a second substrate to which leached polycrystalline diamond 30a or 30b was attached after leaching. Substrate 40 is typically a cemented metal carbide, such as tungsten carbide (WC) grains in a binder or infiltrant matrix, such as a metal matrix. Although FIG. 2 depicts an assembly including a substrate 40, the assembly may also omit a substrate, which may be attached later, if needed.

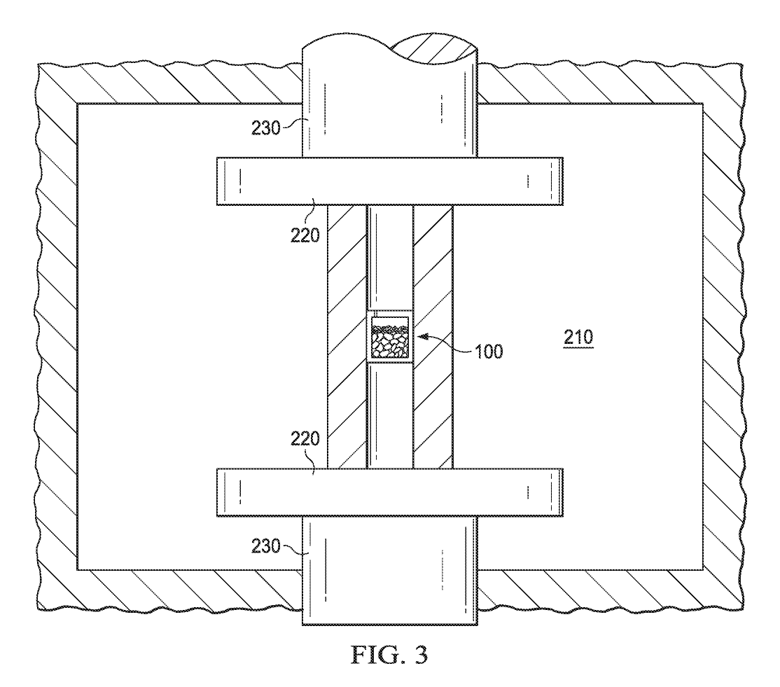

Sealed sintering can 110 includes port 120 through which reactant gas 80 enters sealed sintering can 110 before it is sealed. Reactant gas 80 may be introduced into sealed sintering can 110 before it is placed in spark plasma sintering assembly 200 of FIG. 3 by placing can 110 in a vacuum to remove internal air, then pumping reactant gas 80 into the vacuum chamber. The vacuum chamber may be different from chamber 210 of spark plasma sintering assembly 200, or it may be chamber 210. Port 120 may be sealed with any material able to withstand the spark plasma sintering process, such as a braze alloy.

Sealed sintering can 110 is typically formed from a metal or metal alloy or another electrically conductive material. However, it is also possible to form sealed sintering can from a non-conductive material and then place it within a conductive sleeve, such as a graphite sleeve. A conductive sleeve or non-conductive sleeve may also be used with a conductive sintering can 110 to provide mechanical reinforcement. Such sleeves or other components attached to or fitted around all or part of sintering can 110 may be considered to be part of the sintering can.

During spark plasma sintering (also sometimes referred to as field assisted sintering technique or pulsed electric current sintering) a sintering assembly, such as assembly 100 of FIG. 2, is placed in a spark plasma sintering system, such as system 200 of FIG. 3. Spark plasma sintering system 200 includes vacuum chamber 210 that contains assembly 100 as well as conductive plates 220 and at least a portion of presses 230.

Presses 230 apply pressure to sintering can 100. The pressure may be up to 100 MPa, up to 80 MPa, or up to 50 MPa. Prior to or after pressure is applied, vacuum chamber 210 may be evacuated or filled with an inert gas. If sintering can 100 is filled with reactant gas 80 and sealed in vacuum chamber 210, then before substantial pressure is applied, chamber 210 is evacuated and filled with reactant gas, then port 120 is sealed. Pressure may be applied before or after chamber 210 is evacuated again and/or filled with inert gas.

After vacuum chamber 210 is prepared, a voltage and amperage is applied between electrically conductive plates 220 sufficient to heat reactant gas 80 to a temperature at which reactant gas 80 within pores 50 forms a plasma. For example, the temperature of the reactant gas may be 1500° C. or below, 1200° C. or below, 700° C. or below, between 300° C. and 1500° C., between 300° C. and 1200° C., or between 300° C. and 700° C. The temperature may be below 1200° C. or below 700° C. to avoid graphitization of diamond in polycrystalline diamond segments 30a and 30b or polycrystalline diamond element 30.

The voltage and amperage are supplied by a continuous or pulsed direct current (DC). The current passes through electrically conductive components of assembly 100, such as sealed sintering can 110 and, if electrically conductive, polycrystalline diamond segments 30a and 30b and/or substrate 40. The current density may be at least 0.5×10² A/cm², or at least 10² A/cm². The amperage may be at least 600 A, as high as 6000 A, or between 600 A and 6000 A. If the current is pulsed, each pulse may last between 1 millisecond and 300 milliseconds.

The passing current heats the electrically conductive components, causing reactant gas 80 to reach a temperature, as described above, at which it forms a plasma. The plasma formed from reactant gas 80 contains reactive species, such as atomic hydrogen, protons, methyl, carbon dimmers, and metal ions, such as titanium ions (Ti⁴⁺), vanadium ions (V⁴⁺), and any combinations thereof. The reactive species derived from hydrogen gas or hydrocarbon gas form diamond bonds 90. The metal reactive species form carbide structures 100. Diamond bonds 90 and/or carbide structures 100 may covalently bond to diamond grains 10.

Because spark plasma sintering heats assembly 100 internally as the direct current passes, it is quicker than external heating methods for forming a plasma. Assembly 100 may also be pre-heated or jointly heated by an external source, however. The voltage and amperage may only need to be applied for 20 minutes or less, or even for 10 minutes or less, or 5 minutes or less to form spark plasma sintering-joined polycrystalline diamond. The rate of temperature increase of assembly 100 or a component thereof while the voltage and amperage are applied may be at least 300° C./minute, allowing short sintering times. These short sintering times avoid or reduce thermal degradation of the polycrystalline diamond.

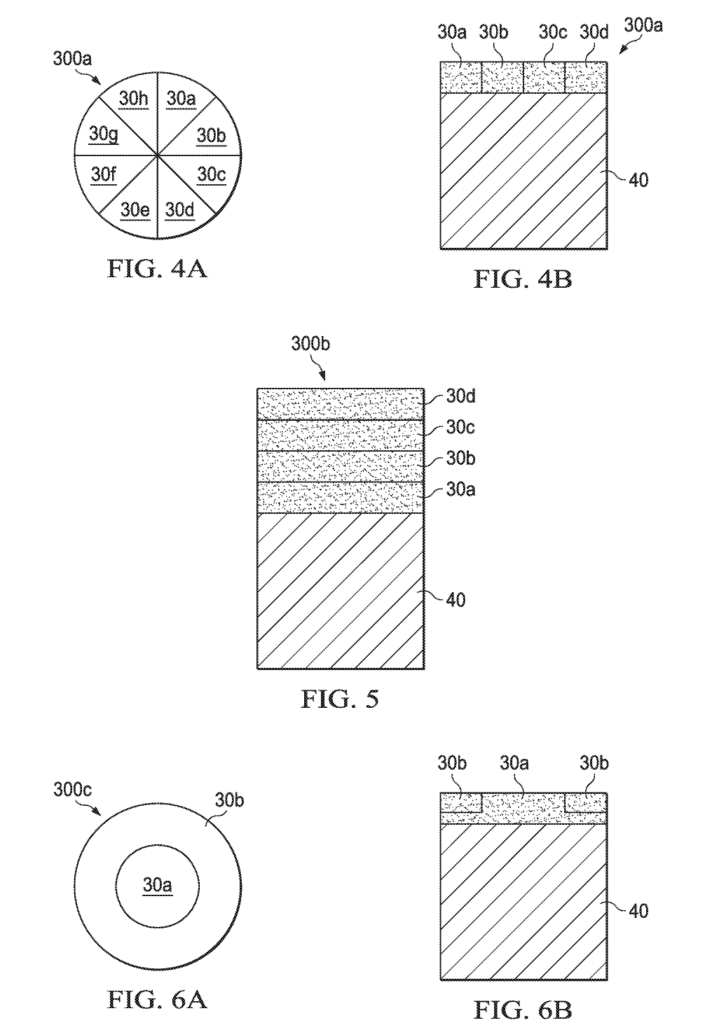

The resulting PDC containing spark plasma sintering-joined polycrystalline diamond element 30 and substrate 40 may in the form of a cutter 300 as shown in FIGS. 4A, 4B, 5, 6A, and 6B. Although the interface between polycrystalline diamond element 30 and substrate 40 is shown as planar in FIGS. 4A, 4B, 5, 6A, and 6B, the interface may have any shape and may even be highly irregular. In addition, although PDC cutter 300 is shown as a flat-topped cylinder in FIGS. 4A, 4B, 5, 6A, and 6B, it may also have any shape, such as a cone or wedge. Polycrystalline diamond segments 30a and 30b, polycrystalline diamond element 30 and/or substrate 40 may conform to external shape features. Furthermore, although polycrystalline diamond element 30 and substrate 40 are illustrated as generally uniform in composition, they may have compositions that vary based on location. For instance, polycrystalline diamond element 30 may have segments or regions with different levels of leaching or different diamond grains (as described above), including different grain sizes in different layers. Properties of different segments or regions formed within polycrystalline diamond element 30 may allow PDC containing it to be self-sharpening as portions or layers of polycrystalline diamond are worn away during use.

Substrate 40 may include reinforcing components, and may have different carbide grain sizes.

If polycrystalline diamond segments 30a and/or 30b in PDC cutter 300 are thermally stable prior to joining or attachment to substrate 40, they may remain thermally stable after attachment, or experience a much lesser decrease in thermal stability than is typically experienced if an elemental metal or metal alloy is reintroduced during attachment because the carbide structures do not negatively affect thermal stability to the degree elemental metals or metal alloys do.

Furthermore, if there is reason to further leach polycrystalline diamond element 30 after its formation by joining or after its attachment to substrate 40, such additional leaching may be performed.

In FIGS. 4A and 4B, PDC cutter 300a contains polycrystalline diamond element 30, formed from laterally spark plasma sintering-joined polycrystalline diamond segments 30a-h. Polycrystalline diamond element 30 is also attached to substrate 40. Polycrystalline diamond segments a-h may alternate or otherwise vary in a polycrystalline diamond property. Although pie-shaped elements are illustrated in FIGS. 4A and 4B, other shapes may be joined laterally. For instance different polycrystalline diamond segments may be in strips, rings, or conical sections. Any geometry may be accommodated to place polycrystalline diamond with a particular property in a particular location on the working surface or side surface of cutter 300a. Although FIG. 4A and FIG. 4B depict linear joints, any joint configuration or shape, including highly irregular joints, is possible.

In FIG. 5, PDC cutter 300b contains polycrystalline diamond element 30, formed from horizontally spark plasma sintering-joined polycrystalline diamond segments 30a-d. Polycrystalline diamond element 30 is also attached to substrate 40. This configuration may be particularly useful in allowing unleached polycrystalline diamond or polycrystalline diamond leached only shallowly at the joint surface, such as segment 30a to be attached to substrate 40. For instance segment 30a may have been formed on substrate 40, providing a very strong bond to the substrate, or may have otherwise been attached to substrate 40 using a binder, infiltrant, or brazing material; additional segments 30b-d may exhibit greater degrees of leaching, ultimately providing a highly leached or thermally stable working surface at segment 30d. Although FIG. 5 depicts four layered segments, any number of layers from two to a plurality may be joined. These layers may have the same or different polycrystalline diamond properties and may be arranged to take advantage of those properties to provide PDC cutter 300 with a longer use life or a self-sharpening features. In addition, although FIG. 5 depicts layers of uniform thickness, layers of different thicknesses may be used. Furthermore, although FIG. 5 depicts planar layers, non-planar layers and even highly irregular joints are possible.

FIGS. 6A and 6B illustrate one way in which both lateral and horizontal spark plasma sintering-joints may be formed. Polycrystalline diamond cutter 300c includes polycrystalline diamond element 30, formed from spark plasma sintering-joined circular segments 30a and 30b. Inner circular segment 30a covers the top of substrate 40 and is joined to the substrate. For instance, inner circular segment 30a may have been formed on substrate 40 or may have otherwise been attached to substrate 40 using a binder, infiltrant, or brazing material. Outer circular segment 30b rests on top of and around inner circular segment 30a and does not contact substrate 40. Thus, the joint between inner circular segment 30a and outer circular segment 30b is both horizontal and vertical in nature. May other configurations may be used as well, with joints that are skewed and neither horizontal or vertical or that are highly irregular.

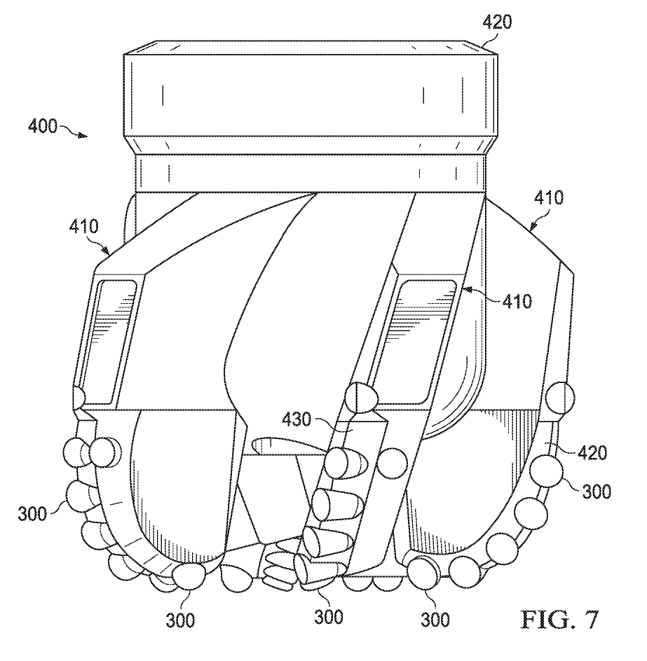

A PDC cutter such as cutter 300 may be incorporated into an earth-boring drill bit, such as fixed cutter drill bit 400 of FIG. 7. Fixed cutter drill bit 400 contains a plurality of cutters coupled to drill bit body 420. At least one of the cutters is a PDC cutter 300 as described herein. As illustrated in FIG. 7, a plurality of the cutters are cutters 300 as described herein. Fixed cutter drill bit 400 includes bit body 420 with a plurality of blades 410 extending therefrom. Bit body 420 may be formed from steel, a steel alloy, a matrix material, or other suitable bit body material desired strength, toughness and machinability. Bit body 420 may also be formed to have desired wear and erosion properties. PDC cutters 300 may be mounted on blades 410 or otherwise on bit 400 and may be located in gage region 430, or in a non-gage region, or both.

Drilling action associated with drill bit 400 may occur as bit body 420 is rotated relative to the bottom of a wellbore. At least some PDC cutters 300 disposed on associated blades 410 contact adjacent portions of a downhole formation during drilling. These cutters 300 are oriented such that the polycrystalline diamond contacts the formation.

Spark plasma sintered PDC other than that in PCD cutters may be attached to other sites of drill bit 400 or other earth-boring drill bits. Suitable attachment sites include high-wear areas, such as areas near nozzles, in junk slots, or in dampening or depth of cut control regions.

The present disclosure provides an embodiment A relating to a method of joining polycrystalline diamond segments via a diamond bond by placing at least two leached polycrystalline diamond segments including pores formed by removal of a diamond sintering aid adjacent one another with a reactant gas including a hydrocarbon gas form in an assembly, and applying to the assembly a voltage and amperage sufficient to heat the reactant gas to a temperature of 1500° C. or less at which the reactant gas forms a plasma, which plasma forms diamond bonds and carbide structures in at least a portion of the polycrystalline diamond pores. The diamond bonds covalently bond the polycrystalline diamond segments to one another to forma polycrystalline diamond element.

The present disclosure further includes an embodiment B relating to a PDC element including polycrystalline diamond segments adjacent one another and covalently bonded to one another by diamond bonds in pores formed by removal of a diamond sintering aid. The PDC element may be formed using the method of embodiment A.

The present disclosure further includes an embodiment C relating to a fixed cutter drill bit including a bit body and a PDC element of embodiment B or formed using embodiment A.

The present disclosure further includes the following elements, which may be combined with any of elements A, B, or C or with one another unless mutually exclusive: i) one or both leached polycrystalline diamond segments may include a leached portion in which less than 2% of the volume is occupied by a diamond sintering aid; ii) the hydrocarbon gas may include methane, acetone, methanol, or any combinations thereof; ii-a) the plasma may include methyl, carbon dimmers, or a combination thereof; iii) the reactant gas may include a carbide-forming metal in gas form; iii-a) the carbide-forming metal in gas form may include a metal salt; iii-b) the plasma may include metal ions; iv) the reactant gas may include a hydrocarbon gas; iv-a) the plasma may include atomic hydrogen, a proton, or a combination thereof; v) the temperature may be 1200° C. or less; vi) the temperature may be 700° C. or less; vii) the voltage and amperage may be supplied by a continuous direct current or a pulsed direct current; viii) the voltage and amperage may be applied for 20 minutes or less; ix) the assembly or any component thereof may have a rate of temperature increase while the voltage and amperage are applied of least 300° C./minute; x) diamond bonds, carbide structures, or both may be formed in at least 25% of the pores of the polycrystalline diamond; xi) the PDC element may be a cutter; xii) the PDC element may be an erosion-resistant element.

Although the present disclosure and its advantages have been described in detail, it should be understood that various changes, substitutions and alternations can be made herein without departing from the spirit and scope of the disclosure as defined by the following claims.

1. A method of forming a polycrystalline diamond element, the method comprising:
placing at least two leached polycrystalline diamond segments comprising pores formed by removal of a diamond sintering aid adjacent one another with a reactant gas comprising a hydrocarbon gas form in an assembly; and
applying to the assembly a voltage and amperage sufficient to heat the reactant gas to a temperature of 1500° C. or less at which the reactant gas forms a plasma, which plasma forms diamond bonds and carbide structures in at least a portion of the polycrystalline diamond pores, wherein diamond bonds covalently bond the polycrystalline diamond segments to one another to form a polycrystalline diamond element.

2. The method of claim 1, wherein both leached polycrystalline diamond segments comprise a leached portion in which less than 2% of the volume is occupied by a diamond sintering aid.

3. The method of claim 1, wherein the hydrocarbon gas comprises methane, acetone, methanol, or any combinations thereof.

4. The method of claim 3, wherein the plasma comprises methyl, carbon dimmers, or a combination thereof.

5. The method of claim 1, wherein the reactant gas further comprises a carbide-forming metal in gas form.

6. The method of claim 5, wherein the carbide-forming metal in gas form comprises a metal salt.

7. The method of claim 5, wherein the plasma comprises metal ions.

8. The method of claim 1, wherein the reactant gas further comprises a hydrocarbon gas.

9. The method of claim 8, wherein the plasma comprises atomic hydrogen, a proton, or a combination thereof.

10. The method of claim 1, wherein the temperature is 1200° C. or less.

11. The method of claim 1, wherein the temperature is 700° C. or less.

12. The method of claim 1, wherein the voltage and amperage are supplied by a continuous direct current or a pulsed direct current.

13. The method of claim 1, wherein the voltage and amperage are applied for 20 minutes or less.

14. The method of claim 1, wherein the assembly or any component thereof has a rate of temperature increase while the voltage and amperage are applied of least 300° C./minute.

15. The method of claim 1, wherein diamond bonds, carbide structures, or both are formed in at least 25% of the pores of the polycrystalline diamond.

16. A polycrystalline diamond compact (PDC) element comprising polycrystalline diamond segments adjacent one another and covalently bonded to one another by diamond bonds in pores formed by removal of a diamond sintering aid.

17. The PDC element of claim 16, comprising diamond bonds, carbide structures, or both in at least 25% of the pores of the PCD.

18. A fixed cutter drill bit comprising:
a bit body; and
a polycrystalline diamond compact (PDC) element comprising polycrystalline diamond element comprising polycrystalline diamond segments adjacent one another and covalently bonded to one another by diamond bonds in pores formed by removal of a diamond sintering aid.

19. The fixed cutter drill bit of claim 18, wherein the PDC element comprises a cutter.

20. The fixed cutter drill bit of claim 18, wherein the PDC element comprises an erosion resistant element.
